(19) United States
(12) Patent Application Publication
(10) Pub. No.: US 2026/0188917 A1
(43) Pub. Date: Jul. 2, 2026

(54) INSULATION PIERCING CONNECTOR WITH INTEGRATED CONDITIONAL ELECTRICAL COUPLING DEVICE

(71) Applicant: Terrasmart, Inc., Cincinnati, OH (US)

(72) Inventors: Christian Mark Kemperman, Grand Haven, MI (US); Benjamin Asher Share, Philadelphia, PA (US)

(21) Appl. No.: 19/046,834

(22) Filed: Feb. 6, 2025

Related U.S. Application Data
(60) Provisional application No. 63/740,610, filed on Dec. 31, 2024.

(51) Int. Cl. H01R 4/2404; H01R 43/01

(52) U.S. Cl. CPC H01R 4/2404; H01R 43/01

(57) ABSTRACT

Connectors and methods for operatively coupling one or more conductors to a trunk cable including an insulating layer. The connector includes first and second jaw assemblies hingedly coupled to each other. At least one of the first jaw assembly and the second jaw assembly includes a blade, a line terminal, and a conditional electrical coupling device. The blade is configured to penetrate the insulating layer of the trunk cable and make electrical contact with the trunk cable when the first jaw assembly and the second jaw assembly are placed into a closed position. The line terminal is configured to receive at least one of the one or more conductors, and the conditional electrical coupling device connects the blade to the line terminal.

### CROSS-REFERENCE TO RELATED APPLICATIONS

The present application claims the filing benefit of co-pending U.S. Provisional Application Ser. No. 63/740,610, filed Dec. 31, 2024, the disclosure of which is incorporated by reference in its entirety.

### FIELD OF THE INVENTION

The present invention relates generally to electrical power transmission systems, and more particularly, to connectors for connecting photovoltaic modules to the electrical power transmission system of a photovoltaic power station.

### BACKGROUND

Photovoltaic power stations, sometimes referred to as solar farms, are large-scale photovoltaic power systems that generate electrical power for the electrical grid. Photovoltaic power stations typically provide a nominal output power in the range of several megawatts, with large stations having a peak outputs in the hundreds of megawatts. Achieving these output levels requires numerous photovoltaic modules spread across a relatively large area, e.g., between three and eight acres per megawatt depending on location.

Each photovoltaic module may include a plurality of photovoltaic cells connected in series. By way of example, a typical photovoltaic module may include 72 photovoltaic cells each producing about 0.75 volts of direct current (DC) when exposed to sunlight in an unloaded condition. The unloaded output of the above photovoltaic module would thus be about 54 volts. Full output power may occur at an amperage where the output voltage drops to a predetermined percentage (e.g., 70%) of its open circuit value, e.g., 38 volts at nine amperes. Accordingly, each of the above described photovoltaic modules would produce about 342 watts at full power. The photovoltaic modules may by arranged into groups (e.g., rows) that are electrically connected in series to define what are known as photovoltaic strings. A typical photovoltaic string may include between 24 and 32 photovoltaic modules, and may be configured to have different sizes, e.g., 1,000, 1,500, 2,000, or more volts. Thus, an exemplary string of the above described photovoltaic modules would have a full power output of between 912 and 1216 volts at nine amperes, and generate between 8,208 and 10,944 watts of electrical power.

In a photovoltaic power station, photovoltaic strings may be arranged into groups, with each string in a group connected to a combiner box or a trunk cable by a wiring harness. Each combiner box/trunk cable may provide a parallel connection between the group of the photovoltaic strings and a DC feeder cable. The DC feeder cable may transport the current generated by the group of strings to a power conversion system that transforms the DC electrical power into alternating current (AC) electrical power suitable for coupling to the electrical grid. For a group of the photovoltaic strings described above having 16 strings, each DC feeder cable could be expected to carry about 144 amperes at between 912 and 1216 volts, thereby delivering between 131 and 175 kW to the power conversion system.

A 100 MW photovoltaic power station would require between 572 and 764 of the above described photovoltaic groups, not accounting for power losses due to conversion inefficiencies, voltage drops across the connecting cables, the accumulation of dust on the photovoltaic modules, etc. Factoring in a 20% power loss, the 100 MW photovoltaic power station could include over 10,000 photovoltaic strings each connected to one of nearly 1,000 combiner boxes/trunk cables by a wiring harness, and another 1,000 pairs of DC feeder cables connecting the combiner boxes/trunk cables to the power conversion system.

Due to the number of photovoltaic modules required, and the area over which those photovoltaic modules must be distributed, fabrication and installation of the power transmission system connecting the photovoltaic modules accounts for significant portion of the total cost of deploying a photoelectric power station. Thus, there is a need for improved systems and methods for operatively coupling photoelectric modules to trunk cables that facilitate fabrication and installation of power transmission systems in photoelectric power stations.

### SUMMARY

In an aspect of the present invention, an insulation piercing connector for operatively coupling one or more conductors to a trunk cable including an insulating layer is provided. The connector includes a first jaw assembly and a second jaw assembly hingedly coupled to the first jaw assembly. At least one of the jaw assemblies includes a blade, a line terminal, and a conditional electrical coupling device. The blade is configured to penetrate the insulating layer of the trunk cable and make electrical contact with the trunk cable when the jaw assemblies are in a closed position. The line terminal is configured to receive at least one of the conductors, and the conditional electrical coupling device connects the blade to the line terminal.

In an embodiment of the connector, the conditional electrical coupling device may include a switch mechanism.

In another embodiment of the connector, the connector may further include a bridge plate having a first electrical contact and a second electrical contact. The at least one of the jaw assemblies may include a body having a cavity with a first end and a second end opposite the first end, the blade may include a third electrical contact positioned at the first end of the cavity, the line terminal may include a fourth electrical contact positioned at the second end of the cavity, and the bridge plate may be configured to move within the cavity between a first position and a second position. In the first position, the first electrical contact may be in contact with the third electrical contact and the second electrical contact may be in contact with the fourth electrical contact such that the switch mechanism is in a closed state. In the second position, at least one of the first electrical contact may be out of contact with the third electrical contact or the second electrical contact may be out of contact with the fourth electrical contact such that the switch mechanism is in an open state.

In another embodiment of the connector, the connector may further include a bridge plate guide having a first standoff, a second standoff, and a crossmember connecting the first standoff and the second standoff. The bridge plate may include a first end and a second end each having a shape. Each standoff may include a guide channel having a cross-sectional shape that matches the shape of the first end and the second end of the bridge plate, and each guide channel may engage a respective one of the first end and the second end of the bridge plate such that the bridge plate is guided by the guide channel as the bridge plate moves between the first position and the second position.

In another embodiment of the connector, the connector may further include a bridge plate plunger having one or more connecting rods, a journal, and a stop plate. Each connecting rod may include a proximal end and a distal end. The stop plate may couple the journal to the proximal end of each connecting rod, and the distal end of each connecting rod may be connected to the bridge plate. The crossmember may be positioned between the bridge plate and the stop plate, and may include one or more guide bores through which the one or more connecting rods pass to connect the stop plate to the bridge plate.

In another embodiment of the connector, the connector may further include a rotary actuator and a linkage operatively coupling the rotary actuator to the journal such that the linkage translates rotation of the rotary actuator into linear movement of the journal.

In another embodiment of the connector, the crossmember may include a guide rod, and the bridge plate may include a guide hole configured to engage the guide rod such that the bridge plate is guided by the guide rod as the bridge plate moves between the first position and the second position.

In another embodiment of the connector, the conditional electrical coupling device may include a protective device.

In another embodiment of the connector, the connector may further include a device holder that holds the protective device, and the at least one of the first jaw assembly and the second jaw assembly may include a body having a cavity with a first end and a second end opposite the first end. The protective device may include a first electrical contact, a second electrical contact, and a protective circuit operatively coupled to the first electrical contact and the second electrical contact. The blade may include a third electrical contact positioned at the first end of the cavity, and the line terminal may include a fourth electrical contact positioned at the second end of the cavity. The cavity may be configured to receive the device holder and the protective device such that when the device holder is inserted into the cavity, the first electrical contact engages the third electrical contact, and the second electrical contact engages the fourth electrical contact, such that the protective device is electrically coupled to the blade and the line terminal.

In another embodiment of the connector, the jaw assemblies may be hingedly coupled to each other by a hinge defining a hinge axis. The first jaw assembly may include a first body having first key on one side thereof and a first keyway on an opposite side thereof, the second jaw assembly may include a second body having a second key on one side thereof and a second keyway on the opposite side thereof, and each key and each keyway may be positioned on the respective side of the respective body at the same radius from the hinge axis as every other key and keyway.

In another embodiment of the connector, the first jaw assembly may be one of a plurality of first jaw assemblies, the second jaw assembly may be one of a plurality of second jaw assemblies, and each first jaw assembly may be hingedly coupled to a respective second jaw assembly to define a respective connector module. The connector may include at least two connector modules, and each of the connector modules may be operatively coupled to at least one other connector module by engagement of one or more keys with one or more keyways.

In another embodiment of the connector, the connector may further include a compression mechanism configured to hold the first jaw assembly and the second jaw assembly in the closed position.

In another embodiment of the connector, the compression mechanism may include a fastener, a first bracket, and a second bracket. The fastener may include a head, a shank, and a threaded end. The first bracket may be configured to engage one of the first jaw assembly and the second jaw assembly, and include a smooth bore configured to allow the threaded end of the fastener to pass therethrough and to allow free rotation of the shank of the fastener. The second bracket may be configured to engage the other of the first jaw assembly and the second jaw assembly, and include a threaded bore configured to receive the threaded end of the fastener. The compression mechanism may be configured to apply a closing force to the first jaw assembly and the second jaw assembly in response to the fastener being rotated in a direction that causes the threaded end thereof to move into the threaded bore as the fastener is rotated.

In another aspect of the present invention, a method of connecting the one or more conductors to the trunk cable having the insulating layer is provided. The method includes placing the first jaw assembly and the second jaw assembly into the closed position such that one or more blades of the at least one of the first jaw assembly and the second jaw assembly penetrate the insulating layer of the trunk cable and make electrical contact with the trunk cable. The method further includes installing the conditional electrical coupling device in one of the first jaw assembly and the second jaw assembly so that the conditional electrical coupling device connects at least one of the one or more blades to the line terminal of the one of the first jaw assembly and the second jaw assembly, and connects at least one of the one or more conductors to the line terminal of the one of the first jaw assembly and the second jaw assembly.

In an embodiment of the method, the conditional electrical coupling device may include at least one of the switch mechanism and the protective device.

In another embodiment of the method, the method may further include inserting the bridge plate having the third electrical contact and the fourth electrical contact into the cavity of the one of the first jaw assembly and the second jaw assembly, and selectively positioning the bridge plate within the cavity so that the third electrical contact contacts the first electrical contact of the one or more blades and the fourth electrical contact contacts the second electrical contact of the line terminal.

In another embodiment of the method, the method may further include selectively positioning the bridge plate within the cavity so that the third electrical contact is out of contact with the first electrical contact of the one or more blades and the fourth electrical contact is out of contact with the second electrical contact of the line terminal.

In another embodiment of the method, selectively positioning the bridge plate within the cavity may include rotating the rotary actuator, and translating the rotation of the rotary actuator into a linear movement of the bridge plate using a linkage that operatively couples the rotary actuator to the bridge plate.

In another embodiment of the method, the method may further include inserting the protective device into the cavity of the one of the first jaw assembly and the second jaw assembly such that the third electrical contact of the protective device contacts the first electrical contact of the one or more blades and the fourth electrical contact of the protective device contacts the second electrical contact of the line terminal.

In another embodiment of the method, the method may further include electrically decoupling the one or more blades from the line terminal in response to the current flowing through the protective device exceeding the threshold.

The above summary presents a simplified overview of some embodiments of the present invention to provide a basic understanding of certain aspects of the present invention discussed herein. The summary is not intended to provide an extensive overview of the present invention, nor is it intended to identify any key or critical elements, or delineate the scope of the present invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the present invention and, together with the general description of the present invention given above, and the detailed description of the embodiments given below, serve to explain the embodiments of the present invention.

FIG. 1 is a schematic view of a photovoltaic power station including a plurality of photovoltaic strings connected to trunk cables with trunk connectors in accordance with an embodiment of the present invention.

FIG. 2 is an isometric view of one of the trunk connectors of FIG. 1.

FIG. 3 is an exploded view of the trunk connector of FIG. 2 depicting a plurality of connector modules each including a pair of jaw assemblies.

FIG. 4 is an exploded view of one of the connector modules of FIG. 3 depicting details of the jaw assemblies, with each jaw assembly including a switch mechanism.

FIG. 5 is an exploded view of one of the switch mechanisms of FIG. 4.

FIGS. 6-8 are isometric, side, and top views of a blade of the switch mechanism of FIG. 5.

FIG. 9 is a cross-sectional view of the jaw assemblies of FIGS. 3 and 4 in an open position.

FIG. 10 is a cross-sectional view of the jaw assemblies of FIG. 9 in a closed position.

FIG. 11 is an exploded view of a switch actuation mechanism for actuating the switch mechanism of FIGS. 4 and 5.

FIGS. 12-15 are cross-sectional views showing operation of the actuation mechanism of FIG. 11.

FIG. 16 is an isometric view of the trunk connector showing an alternative embodiment of the switch actuation mechanism.

FIG. 17 is an exploded view of another embodiment of the trunk connector having an alternative housing and in which each jaw assembly is configured to receive an overcurrent protective device.

FIG. 18 is an isometric view of an embodiment of a jaw assembly of FIG. 17 depicting additional details of the overcurrent protective device.

FIG. 19 is a cross-sectional view of the jaw assembly of FIG. 18.

It should be understood that the appended drawings are not necessarily to scale, and may present a somewhat simplified representation of various features illustrative of the basic principles of the present invention. The specific design features of the sequence of operations disclosed herein, including, for example, specific dimensions, orientations, locations, and shapes of various illustrated components, may be determined in part by the particular intended application and use environment. Certain features of the illustrated embodiments may have been enlarged or distorted relative to others to facilitate visualization and a clear understanding. In particular, thin features may be thickened, for example, for clarity or illustration.

### DETAILED DESCRIPTION

The values provided herein (e.g., photovoltaic power station size, photovoltaic string or module size, voltage, current, and number, as well as the number and size of trunk cables, etc) are exemplary only and intended solely for illustrative purposes. Accordingly, any numerical values disclosed are not intended to limit the scope of the invention, and variations may be applicable depending on the specific configuration, design, or operational conditions of the solar power plant in question. For example, actual current and voltage values may vary based on factors such as system design, geographical location, solar irradiance, temperature, and other environmental or system-related conditions. Accordingly, the invention is not confined to the specific values presented, and the claims of this patent application should be interpreted to encompass a range of potential values within the intended scope of the invention.

Embodiments of the present invention include a connector for connecting a conductor (such as a lead from a wiring harness) to a trunk cable, and may be particularly useful for electrical transmission systems that connect photovoltaic strings to power conversion systems. The connector may have a modular configuration that enables the number of wiring harnesses which can be connected to the trunk cable by the connector to be selectively modified in the field. Advantageously, this modular feature may allow installers to customize the connector to a particular connection without having to maintain an inventory of different connectors pre-configured to accommodate different numbers of conductors.

Embodiments of the connector may also include one or more integrated conditional electrical coupling devices that conditionally couple the conductor to the trunk cable. As used herein, the term “conditional electrical coupling device” refers to a device that connects multiple conductors (e.g., two conductors) and which has a closed state and an open state. While in the closed state, the conditional electrical coupling device electrically couples the two conductors to which it is connected. While in the open state, the conditional electrical coupling device does not electrically couple the two conductors to which it is connected. Exemplary conditional electrical coupling devices may include switch mechanisms (e.g., a cutoff switch), an overcurrent protective device (e.g., a fuse), or a combination switch mechanism/overcurrent protective device (e.g., a circuit breaker).

Embodiments of the connector including a switch mechanism may enable technicians to manually disconnect a specific conductor from the trunk cable. Advantageously, this switch feature may facilitate installation and maintenance of electrical equipment (such as a photovoltaic string) by providing a convenient way to electrically isolate a specific conductor from the trunk cable. The integrated conditional electrical coupling device feature may also reduce the need to deploy separate cutoff switches or protective devices, thereby simplifying installation of the electrical power transmission system.

It should be understood that when a component is referred to as being “coupled” or “connected” to another component, the components may be directly coupled or connected to each other or coupled or connected through intervening components. In contrast, when components are referred to as being “directly coupled” or “directly connected”, this indicates that there are no intervening components between the directly connected or directly coupled components. Components referred to as being “operatively coupled” are connected so that they function together in a way that allows them to influence each other's operation so that they work together to achieve a desired outcome. Operatively coupled components may be directly coupled (e.g., physically attached to each other) or indirectly coupled (e.g., connected through a mediating mechanism).

Relative terms, such as “left”, “right”, “upper”, “lower”, “front”, “back”, “proximate”, “distal”, “top”, “bottom”, “horizontal”, “vertical”, etc., may be used herein for convenience to clearly describe relationships between components or features as they are depicted in the figures. However, it should be understood that these terms are relative and not intended to define an absolute orientation, position, or arrangement of the components relative to each other or in their operating environment unless clearly indicated otherwise in the description.

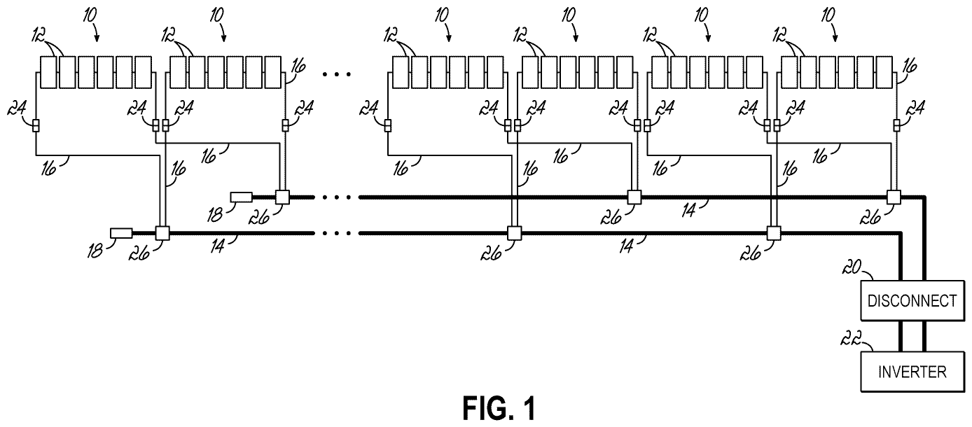

FIG. 1 depicts a portion of an exemplary photovoltaic power station including a plurality of photovoltaic strings 10. Each photovoltaic string 10 may include a plurality of photovoltaic modules 12 that are connected in series and operatively coupled to one or more trunk cables 14 (e.g., a positive trunk cable or a negative trunk cable) by one or more wiring harnesses 16. The trunk cables 14 may include a relatively large conductor that connects photovoltaic panels to DC/AC inverters, and may carry high-level currents between the low-voltage DC network. Each trunk cable 14 may include one or more trunk conductors (e.g., copper wires, aluminum wires, or any other suitable conductors) surrounded by one or more insulating layers (e.g., cross-linked polyethylene, high density polyethylene, or any other suitable insulating layer). Each trunk cable 14 may further include a distal end covered by an insulting end cap 18 and a proximate end connected to a disconnect box 20. The disconnect box 20 may be configured to enable the trunk cables 14 to be selectively coupled to an inverter 22. The inverter 22 may be part of a power conversion system that operatively couples electrical power generated by the photovoltaic power station to the electrical grid.

Each wiring harness 16 may include a feed end terminated by a feed connector 24 and a trunk end terminated by a trunk connector 26. The feed connector 24 may connect the wiring harness 16 to one of the positive output or the negative output of a photovoltaic string 10, and the trunk connector 26 may connect the wiring harness 16 to one of a positive trunk cable 14 or a negative trunk cable 14. In the depicted embodiment, each wiring harness 16 is shown as operatively coupling one end of a single photovoltaic string 10 to a corresponding trunk cable 14, and each trunk connector 26 is shown as operatively coupling two wiring harnesses to a trunk cable 14. However, it should be understood that the depicted embodiment is exemplary only, and embodiments of the present invention are not limited to use with any particular number of photovoltaic strings 10, number of wiring harnesses 16 used to connect the photovoltaic strings 10 to the trunk cable 14, number of photovoltaic modules 12 per photovoltaic string 10, or number of wiring harnesses coupled to the trunk busses by each trunk connector 26.

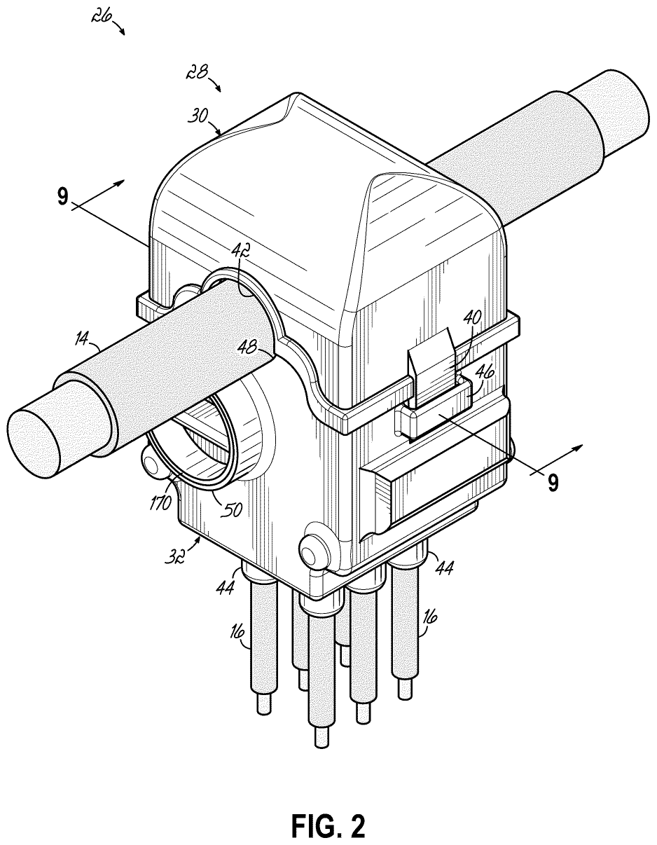

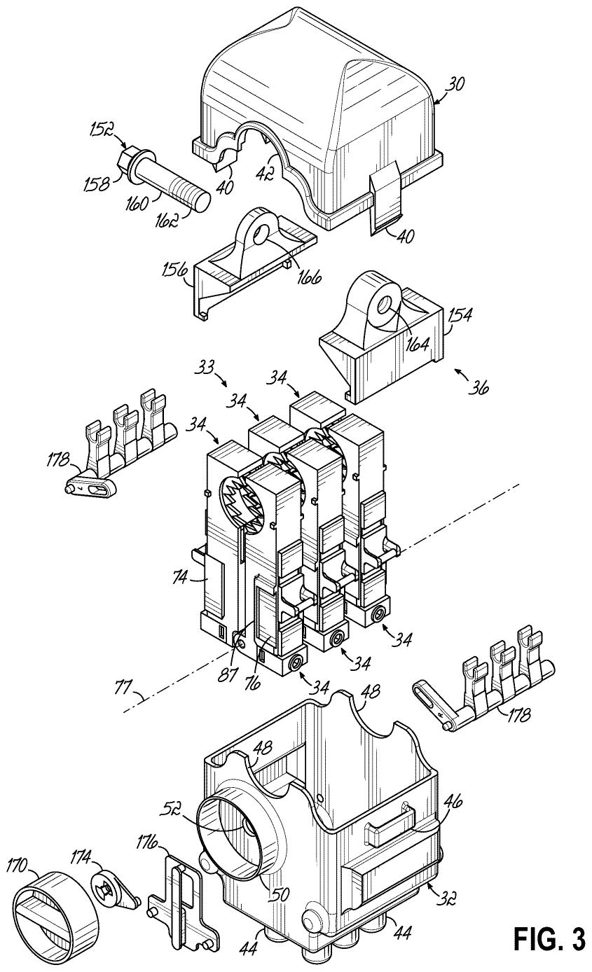

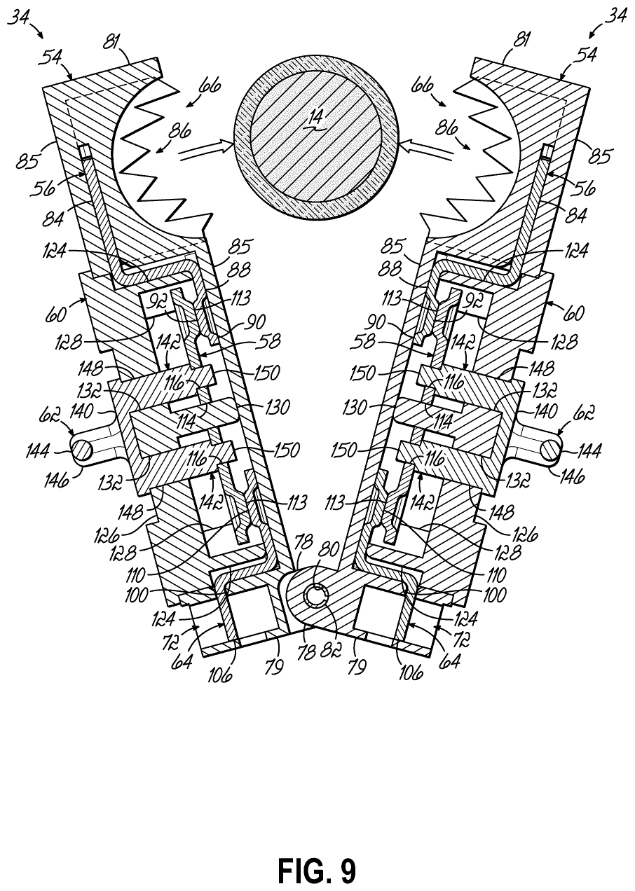

FIGS. 2 and 3 depict an exemplary trunk connector 26 including a conditional electrical coupling device (e.g., a switch mechanism) in accordance with an embodiment of the present invention. The trunk connector 26 includes a housing 28 having an upper portion 30 and a lower portion 32, and a plurality of connector modules 33 each comprising a pair of hingedly coupled jaw assemblies 34, a compression mechanism 36 configured to hold the jaw assemblies 34 in a closed position, and a switch actuation mechanism 38 (see FIG. 9). The jaw assemblies 34 may be configured so that when the trunk connector 26 is connected to the trunk cable 14, the trunk cable passes through the trunk connector 26. In cases where the trunk connector 26 is installed at the end of a trunk cable 14, a cap (not shown) may be used to cover the unused trunk cable opening and seal the housing 28. In this embodiment, the insulting end cap 18 may be omitted. Although FIG. 2 depicts a trunk connector 26 including three connector modules 33, it should be understood that embodiments of the present invention are not limited to trunk connectors 26 having any specific number of connector modules 33. As described in further detail below, the number of connector modules 33 used for any particular trunk connector 26 may depend on the specific needs of the connection in question. However, by way of example only, a typical number of connector modules 33 used in a trunk connector 26 may range from one to four connector modules 33, but is not limited to four.

The upper portion 30 of housing 28 may include one or more barbed tabs 40 that project towards the lower portion 32 of housing 28, and a pair of cutouts 42 (e.g., semicircular cutouts. The cutouts 42 may be configured to receive the outer surface of the trunk cable 14 to which the trunk connector 26 is attached, and may also form a weather-tight seal with the outer surface of the trunk cable 14. The lower portion 32 of housing 28 may include one or more sleeves 44 (e.g., two sleeves 44) that project outward from a rear surface thereof, one or more slots 46 on one or more of a top surface and bottom surface thereof, a pair of cutouts 48 (e.g., semicircular cutouts) on a left surface and a right surface thereof, and a cylinder 50 projecting outward from one of the left surface or right surface thereof. The bottom surface of cylinder 50 may include an opening 52 that provides access to the interior of housing 28.

Each sleeve 44 of the lower portion 32 of housing 28 may be configured to receive the trunk end of a wiring harness 16. The cutouts 42, 48 may be configured to engage the outer surface of trunk cable 14 when the upper portion 30 is engaged with the lower portion 32 of housing 28. Each slot 46 may be configured to receive a respective barbed tab 40 of the front portion of housing 28 such that when the front and rear portions of housing 28 are engaged, the barbed tabs 40 and slots 46 form retaining catches that hold the housing 28 together.

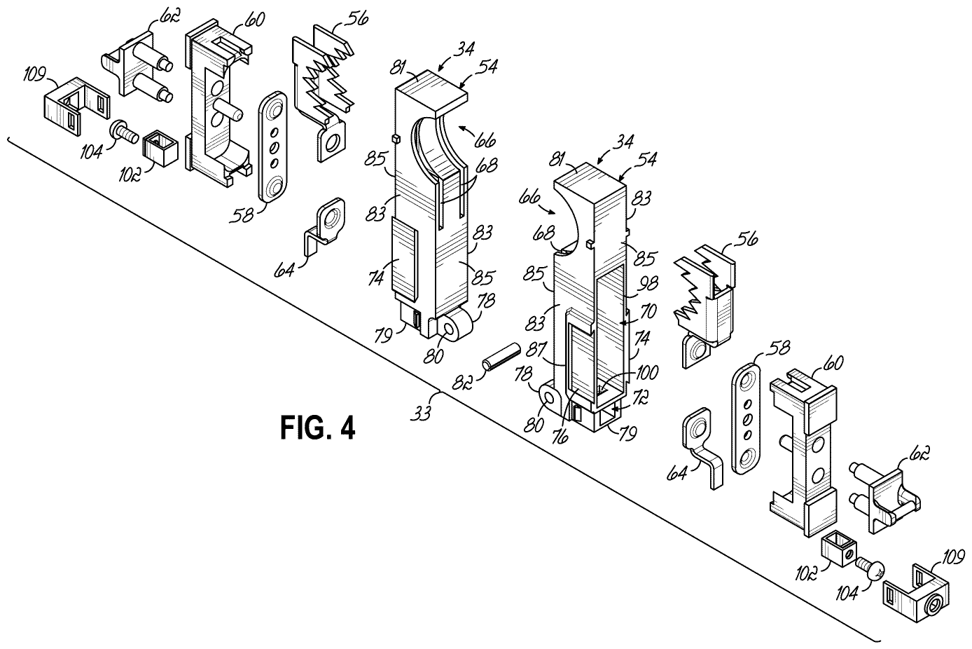

Referring now to FIG. 4, and with continued reference to FIG. 3, FIG. 4 depicts additional details of an exemplary connector module 33 of trunk connector 26. Each jaw assembly 34 may include a body 54, a blade 56, a bridge plate 58, a bridge plate guide 60, a bridge plate plunger 62, and a line terminal 64. The body 54 of upper jaw assembly 34 may include a cable groove 66, one or more blade slots 68 that intersect the cable groove 66, a main cavity 70, a terminal cavity 72, one or more keys 74, one or more keyways 76 each configured to receive a key 74, and one or more hinge barrels 78. Each hinge barrel 78 may be positioned at a proximate end of body 54, and may include a hinge bore 80 configured to receive a hinge pin 82. The one or more hinge barrels 78 of the upper and lower jaw assemblies 34 may be configured to engage each other so that the hinge barrels 78 of the different jaw assemblies 34 are juxtaposed in a staggered arrangement that allows the hinge bore 80 of each barrel to receive the hinge pin 82 and thereby form a hinge joint having a hinge axis 77. Once so joined, the upper and lower jaw assemblies 34 may pivot about the hinge axis 77.

Each body 54 may include a proximal surface 79, a distal surface 81 opposite the proximal surface 79, two opposing lateral surfaces 83, and two opposing vertical surfaces 85. A key 74 may be positioned on one of the lateral surfaces 83 of each body 54, and a keyway 76 may be positioned on the other of the lateral surfaces 83 of each body 54 opposite the key 74. The key 74 and keyway 76 may be positioned on their respective lateral surfaces 83 so that they are generally the same distance from the hinge axis 77. That is, the key 74 and keyway 76 may be configured to rotate about the hinge axis 77 at the same radius therefrom as the hingedly coupled jaw assemblies 34 are moved relative to each other. Two connector modules 33 may be operatively coupled to each other by engaging one or more keys 74 of one connector module 33 with one or more keyways 76 of the other connector module 33.

Each key 74 may be engaged with a respective keyway 76 by positioning the upper and lower jaw assemblies 34 such that each keyway 76 on the confronting lateral surfaces 83 of the bodies 54 being joined is horizontally aligned with a corresponding key 74 on the opposing body 54. Each key 74 may then be inserted into its respective keyway 76 by sliding the key 74 vertically along the keyway 76 until the key 74 encounters a key stop 87. The keyway 76 may be configured to receive all or a portion of the key 74. The key 74 and keyway 76 may be configured such that the proximal surfaces 79, distal surfaces 81, and vertical surfaces 85 of the joined bodies 54 are generally flush with each other when one or more keys 74 of one body 54 are fully inserted into one or more keyways 76 of the other body 54. The keys 74 and keyways 76 may thereby enable connector modules 33 to be operatively coupled to each other in the field to define trunk connectors 26 capable of connecting any number of wiring harnesses 16 to a trunk cable 14.

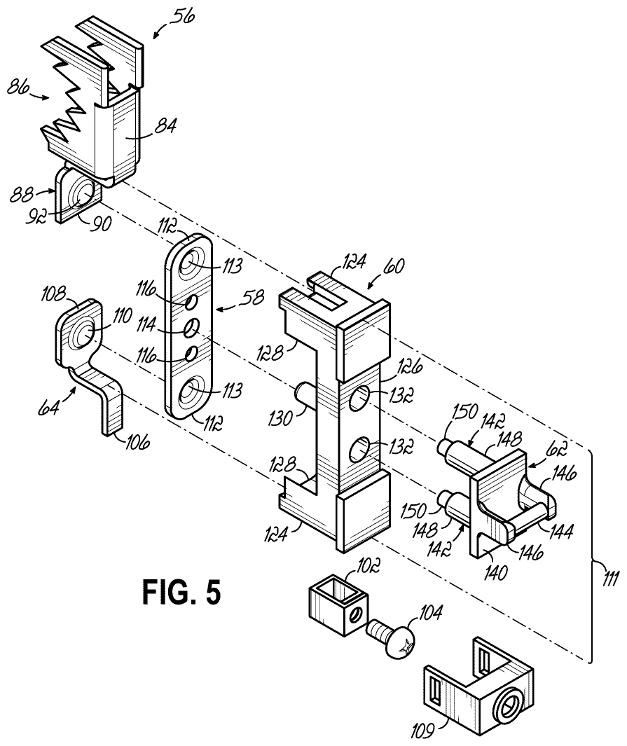

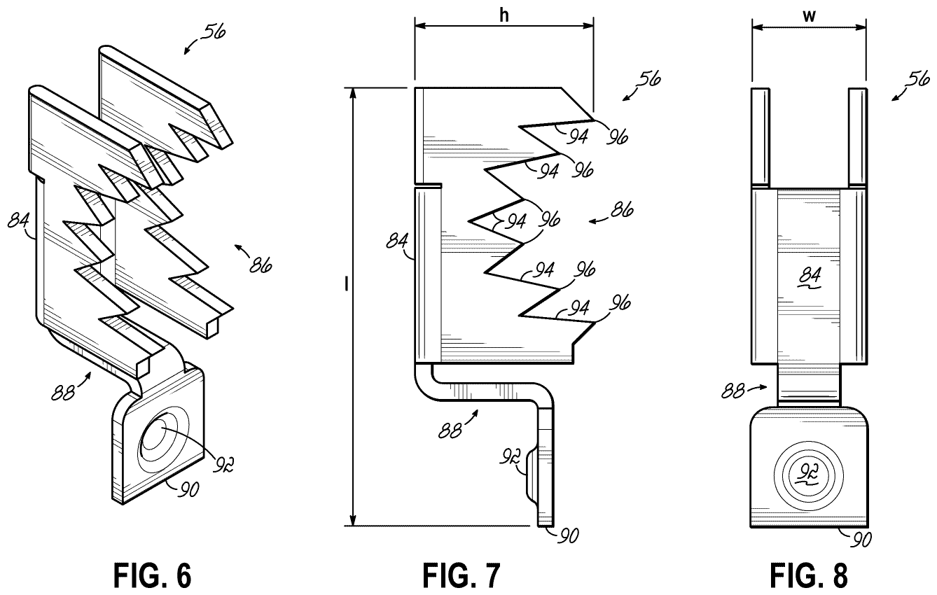

FIG. 5 depicts an exploded view of the switch mechanism 111, and FIGS. 6-8 depict the blade 56 in detail. Each blade 56 may include a fillet 84, a plurality of insulation piercing features 86 (e.g., two insulation piercing features 86), and a blade terminal 88 having a distal end 90 with an electrical contact 92. Each insulation piercing feature 86 may extend downward at an angle (e.g., a right angle) from the fillet 84 such that the insulation piercing features 86 are generally parallel to each other and separated by the width of the fillet 84. The blade terminal 88 may initially project downward at an angle (e.g., a right angle) from the fillet 84, with the distal end 90 of blade terminal 88 oriented upward at an angle (e.g. a right angle) such that the distal end 90 of blade terminal 88 is generally parallel to and downwardly offset from the fillet 84. Each insulation piercing feature 86 of blade 56 may include one or more teeth 94 each having a point 96 The points 96 may be arranged along one or more arcs generally corresponding to an outer surface of the trunk cable conductor or conductors. In any case, trunk connector 26 may be configured to receive differently sized blades 56 and to accommodate different sized trunk cables 14.

The dimensions of the blade 56 may vary in accordance with the size of the trunk cable 14. According to some embodiments configured for use with a trunk cable 14 including a 7.7/0 stranded conductor, the blade 56 may have a length l of 35-70 mm (e.g., 50 mm), a width w of 9-18 mm (e.g., 13 mm), and a height h of 15-30 mm (e.g., 22 mm), and be made from a sheet of metal having a thickness of about 0.7-1.4 mm (e.g., 1 mm). The blade 56 may be formed of any suitable electrically conductive material, e.g., a suitable metal such as aluminum, aluminum alloy, copper, copper alloy, etc., and may be coated (e.g., galvanized). The blade 56 may be formed using any suitable technique, and may be monolithic and unitarily formed. According to some embodiments, the blade 56 may extruded and cut, cast, machined, or stamped (e.g., die-cut) and bent into shape.

The main cavity 70 may include an opening 98 on the vertical surface 85 of body 54 opposite the side including the cable groove 66 so that the main cavity 70 can be accessed while the jaw assemblies 34 are in the closed position. The blade slots 68 of body 54 may be configured to receive the insulation piercing features 86 of blade 56. The blade 56, cable groove 66, and blade slots 68 may be so sized and shaped that the points 96 of teeth 94 extend into the cable groove 66 by an amount sufficient to penetrate the insulating layers of trunk cable 14 and make electrical contact with the one or more trunk conductors of trunk cable 14 when the jaw assemblies 34 are in the closed position. The blade 56 may be configured so that when it is fully inserted into the blade slots 68 of body 54, the distal end 90 of blade terminal 88 is positioned within the main cavity 70 at a distal end thereof.

The terminal cavity 72 may be configured to receive a box lug 102 and a screw 104, and may be connected to the main cavity 70 by a passage 100. The line terminal 64 may include a proximal end 106 and a distal end 108 having an electrical contact 110. The distal end 108 of line terminal 64 may be positioned at a proximate end of the main cavity 70 opposite the distal end thereof. The proximal end 106 of line terminal 64 may extend upward from the distal end 108 thereof, and may be bent at an angle such that the proximal end 106 extends through the passage 100 and into the terminal cavity 72. The box lug 102 and screw 104 may be configured to clamp or release a conductor (e.g., the end of a wire from wiring harness 16) to establish an electrical connection between the conductor and the line terminal 64. A terminal cavity cover 109 may be placed over the terminal cavity 72 to prevent inadvertent contact with the line terminal 64, box lug 102, or screw 104 when the trunk connector 26 is connected to a live circuit. Although the exemplary embodiment depicted by FIG. 5 includes a box lug 102 and screw 104 connection, in an alternative embodiment, the conductor may be connected to the connector 26 using a compression style connection or an insulation piercing connection. Accordingly, embodiments of the invention are not limited to any particular type of conductor connection.

The main cavity 70 may be configured to contain a switch mechanism 111 comprising the bridge plate 58, bridge plate guide 60, bridge plate plunger 62, electrical contact 92 of blade terminal 88, and electrical contact 110 of line terminal 64. The bridge plate 58 may comprise an elongated bar of conductive material (e.g., copper or copper alloy) that has curved ends 112 each including an electrical contact 113. The bridge plate 58 may further include one or more guide holes 114 (e.g., one centrally positioned guide hole 114) and one or more pilot holes 116 (e.g., two pilot holes 116, one on either side of the guide hole 114).

The bridge plate guide 60 may include a plurality of standoffs 124 (e.g., two standoffs 124) connected by a crossmember 126. Each standoff 124 may include a guide channel 128 having a cross-sectional shape that generally matches the shape of the curved end 112 of bridge plate 58. The crossmember 126 may include one or more guide rods 130 (e.g., one guide rod 130) that are generally parallel to the guide channels 128. The crossmember 126 of bridge plate guide 60 may include one or more guide bores 132, e.g., two guide bores 132 each positioned between the guide channels 128 and guide rod 130. The guide bores 132 may be generally parallel to, and offset vertically from, the guide channels 128 and guide rods 130.

The bridge plate plunger 62 may include a stop plate 140, one or more connecting rods 142 that extend downward from the stop plate 140, and a journal 144. The stop plate 140 may include one or more lugs 146 that hold the journal 144 in an elevated position above the stop plate 140. By way of example, the stop plate 140 may include two plate lugs 146 each coupling one end of the journal 144 to the stop plate 140. Each connecting rod 142 may include a shaft 148 configured to move reciprocatively within a respective guide bore 132, and a tip 150 that extends from the end of the shaft 148. The tip 150 may have a diameter smaller than that of the shaft 148 from which it extends, and a length such that the tip 150 extends a predetermined distance beyond the bridge plate 58 when the shaft 148 is fully seated thereon.

During assembly of the switch mechanism 111, the guide rod 130 may be inserted into the guide hole 114 of bridge plate 58, and the tip 150 of each connecting rod 142 may be inserted into a respective pilot hole 116 of bridge plate 58. While the shaft 148 is fully seated on the bridge plate 58, the portion of each tip 150 extending from the bridge plate 58 may be deformed so as to define a shop-head that fastens the connecting rod 142 to the bridge plate 58. The assembled bridge plate mechanism may be inserted into the main cavity 70 of the body 54 of jaw assembly 34 subsequent to insertion of the blade 56 and line terminal 64 to complete the switch mechanism 111. The above described switch mechanism 111 may provide a switching feature to the trunk connector 26 that enables each wiring harness 16 connected to the trunk cable 14 to be electrically coupled to, and electrically decoupled from, the trunk cable 14. The state of electrical coupling (closed state) or electric decoupling (open state) may be selected by moving the electrical contacts of bridge plate 58 into and out of contact with the electrical contacts of blade 56 and line terminal 64.

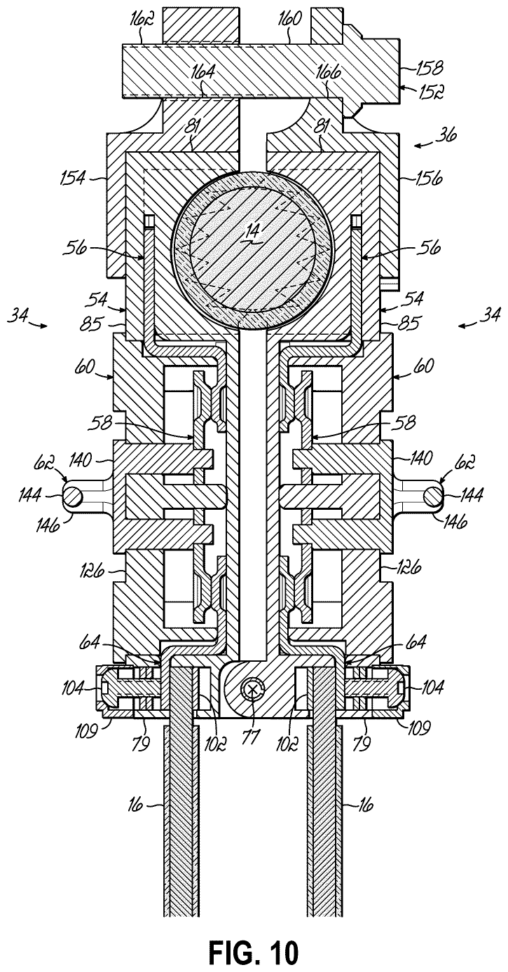

Referring to FIGS. 9 and 10, and with continued reference to FIG. 3, the compression mechanism 36 may include a threaded fastener 152 (e.g., a bolt), a distal bracket 154, and a proximal bracket 156. The threaded fastener 152 may include a head 158, a shank 160, and a threaded end 162. The distal bracket 154 may include a threaded bore 164 configured to receive the threaded end 162 of threaded fastener 152. The proximal bracket 156 may include a smooth bore 166 so sized and shaped as to allow both the shank 160 and threaded end 162 of threaded fastener 152 to pass freely therethrough. In operation, the trunk cable 14 may be positioned in the cable grooves 66 of the one or more jaw assemblies 34 of trunk connector 26, and the jaw assemblies 34 put into a closed position. The distal bracket 154 and proximal bracket 156 may then be positioned to engage the ends of the jaw assemblies 34 opposite the hinges thereof, and the threaded fastener 152 tightened to a predetermined torque. Tightening the threaded fastener 152 may apply a closing force to the jaw assemblies 34 proportional to the torque applied to the head 158 of threaded fastener 152. In an embodiment of the present invention, the head 158 of threaded fastener 152 may be a shear head including a breakaway section configured to shear off when subjected to a predetermined torque. The shear head may thereby limit the amount of closing force that is applied to the jaw assemblies 34. In an alternative embodiment, the distal bracket 154 may include a smooth bore, and the threaded fastener 152 may be held in place by a nut (not shown). In this embodiment, either one of the head 158 or threaded fastener 152 may include a breakaway section.

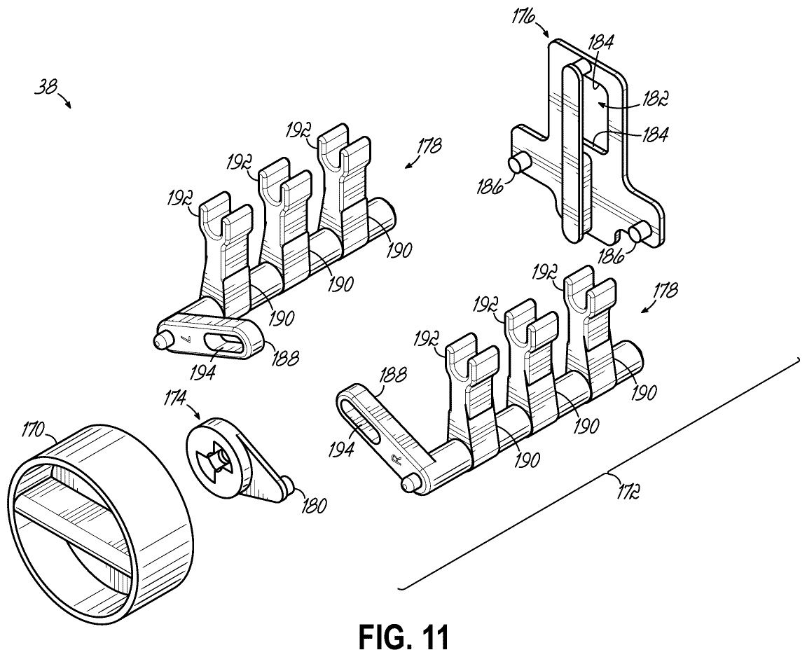

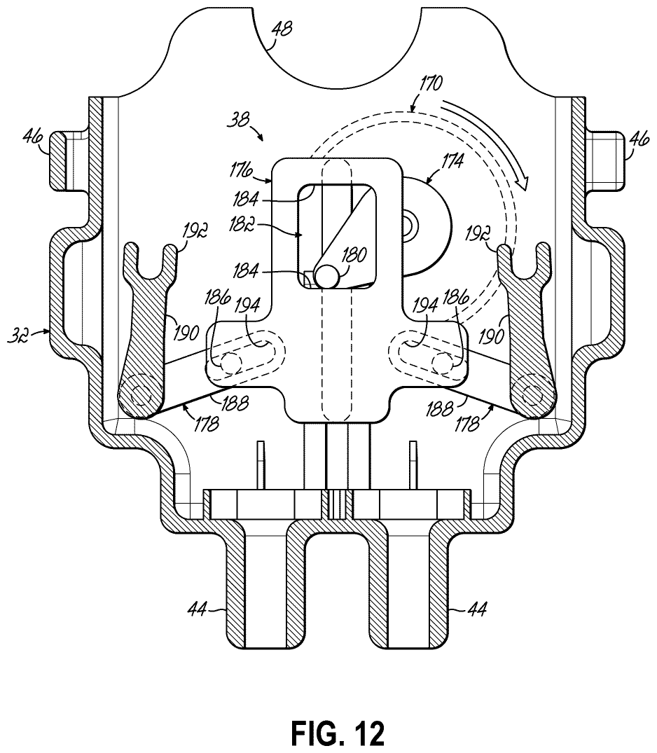

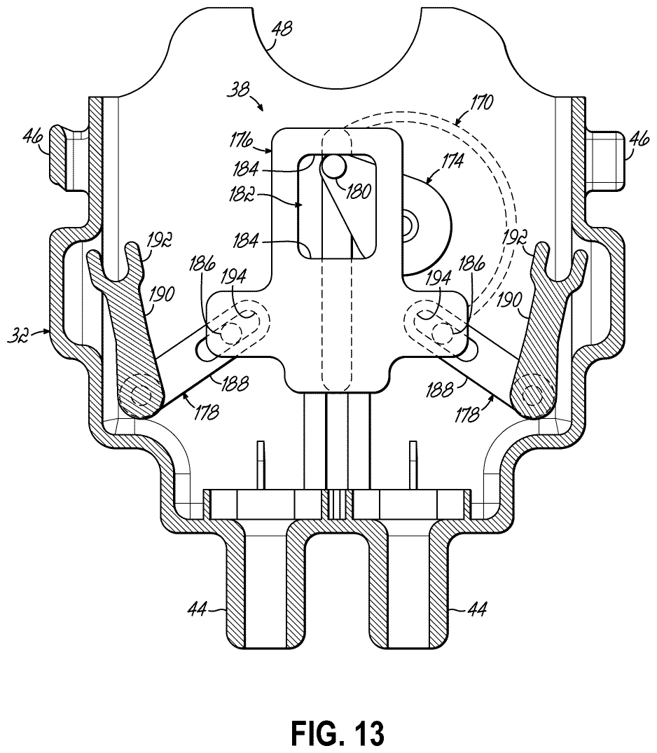

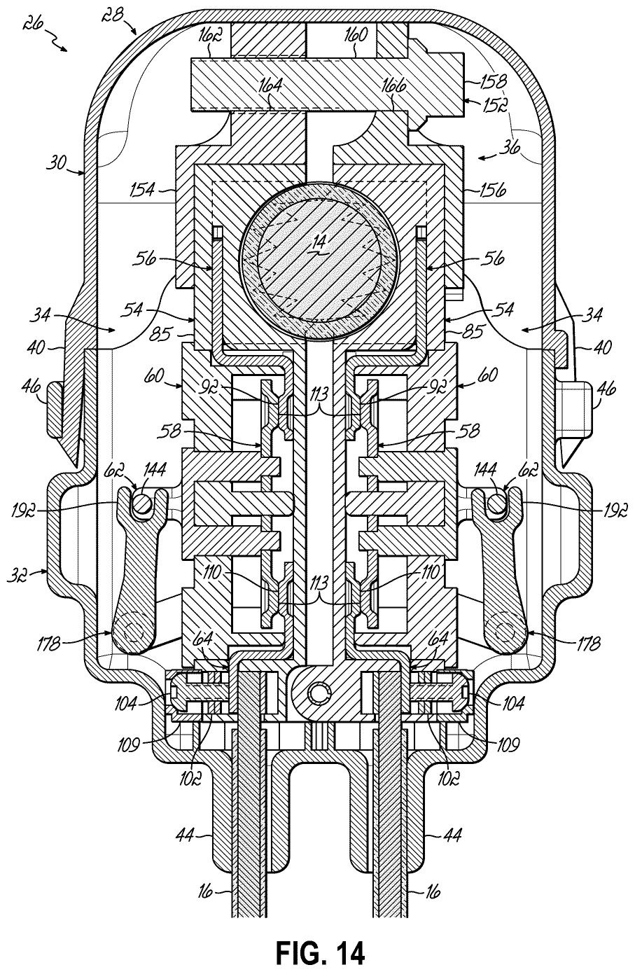

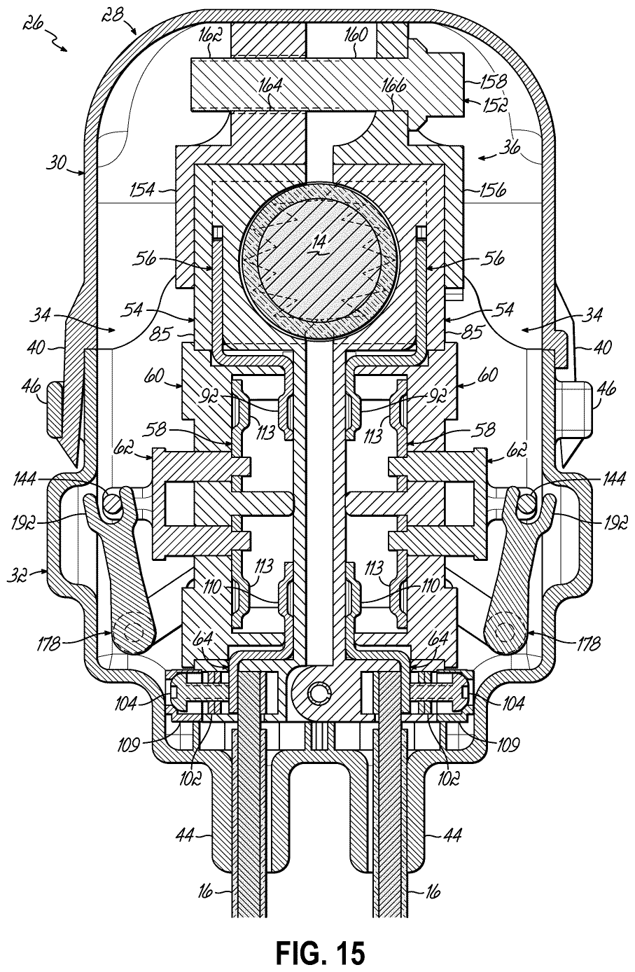

Referring now to FIGS. 11-15, and with continued reference to FIGS. 2 and 3, the switch actuation mechanism 38 may include a rotary actuator 170 positioned in the cylinder 50 of the lower portion 32 of housing 28, and a linkage 172 that operatively couples the rotary actuator 170 to the bridge plate plungers 62. The linkage 172 may be configured to transform rotary movement of the rotary actuator 170 into linear movement at each bridge plate plunger 62 of trunk connector 26. The linkage 172 may include a switch blade plate 174, a sliding track bar 176, and one or more bellcranks 178. The switch blade plate 174 may be coupled to the rotary actuator 170 along a common axis of rotation (e.g., through the opening 52 of cylinder 50) and include a radially offset projection 180. The sliding track bar 176 may include an opening 182 having one or more sides 184, and one or more projections 186. The sides 184 of the opening 182 of sliding track bar 176 may be alternately engaged by the projection 180 of switch blade plate 174 in response to rotation of the rotary actuator 170. Engagement by the projection 180 of switch blade plate 174 may cause the sliding track bar 176 to move linearly by a predetermined amount in one of two reciprocal directions depending on which side 184 of opening 182 is engaged. Each bellcrank 178 may be configured to rotate about an axis within the housing 28 of trunk connector 26, and include an input arm 188 and one or more output arms 190, with each output arm 190 including a yoke 192. The input arm 188 of each bellcrank 178 may include a slot 194 configured to receive a respective projection 186 of sliding track bar 176. The yoke 192 of each output arm 190 may be configured to engage the journal 144 of a respective bridge plate plunger 62.

In operation, the projections 186 of sliding track bar 176 may transfer linear movement to the upper and lower bellcranks 178. Each bellcrank 178 may transfer this movement to the one or more bridge plate plungers 62. Each bridge plate 58 may move linearly within the bridge plate guide 60 in response to movement of the bridge plate plunger 62. One of the electrical contacts 113 of bridge plate 58 may be configured to engage the electrical contact 92 of blade 56, and the other electrical contact 113 of bridge plate 58 may be configured to engage the electrical contact 110 of line terminal 64. The range of motion allowed within the bridge plate guide 60 may be determined by the dimensions of the crossmember 126 and shafts 148. The guide channels 128 and guide rod 130 may locate the bridge plate 58 laterally as it moves linearly back and forth within the bridge plate guide 60 so that the electrical contacts 113 come into and go out of contact with the electrical contact 92 of blade 56 and electrical contact 110 of line terminal 64. Movement of the bridge plate plunger 62 may thereby result in the opening and closing of one or more electrical circuits between the one or more wiring harnesses 16 and the trunk cable 14 to which the trunk connector 26 is connected.

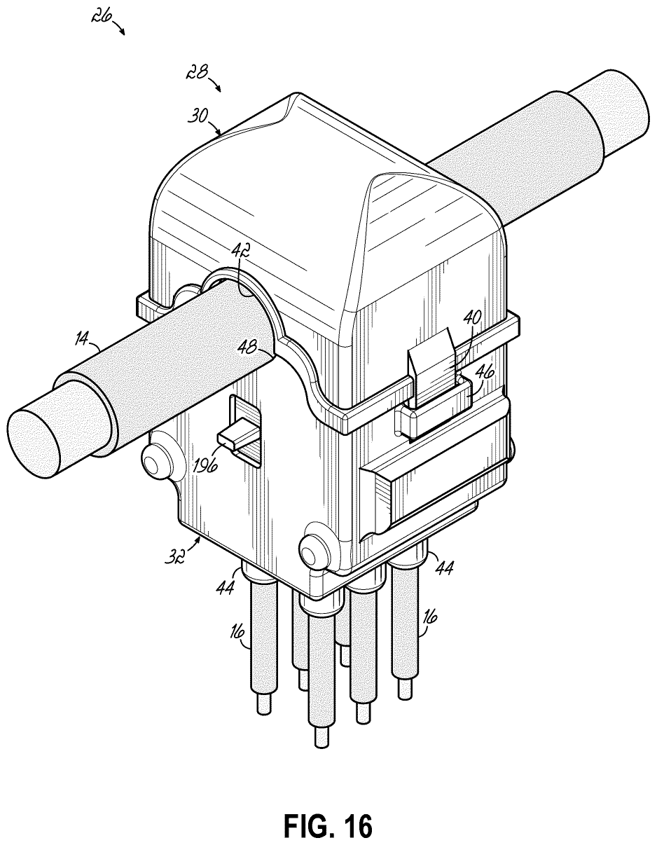

FIG. 16 depicts an alternative embodiment of the trunk connector 26 in which the rotary actuator 170 has been replaced by a sliding actuator 196. The sliding actuator 196 may include a projection (not shown) that engages the sides 184 of opening 182 of sliding track bar 176 in essentially the same manner as the projection 180 of switch blade plate 174. Engagement of the sides 184 of opening 182 may be in response to linear movement of the sliding actuator 196 instead of in response to rotation of the rotary actuator 170. Engagement by the projection of sliding actuator 196 may cause the sliding track bar 176 to move linearly by a predetermined amount in one of two reciprocal directions depending on which side 184 of opening 182 is engaged, thereby opening and closing the one or more electrical circuits between the one or more wiring harnesses 16 and the trunk cable 14 to which the trunk connector 26 is connected.

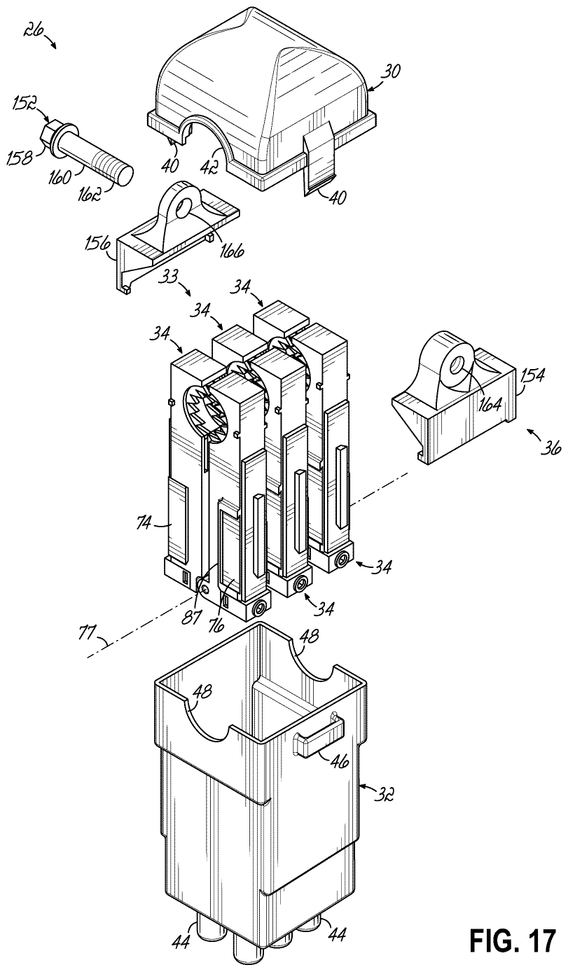

FIGS. 17-19 depict another exemplary embodiment of the trunk connector 26 that includes an integrated protective device in accordance with an embodiment of the present invention. The trunk connector 26 includes a housing 28 having an upper portion 30 and a lower portion 32, a plurality of connector modules 33 (e.g., four connector modules 33) each including a pair of hingedly coupled jaw assemblies 34, and a compression mechanism 36 configured to hold the jaw assemblies 34 in the closed position. Although FIG. 17 depicts a trunk connector 26 including three connector modules 33, as noted with respect to FIGS. 2 and 3 above, it should be understood that embodiments are not limited to trunk connectors 26 having any specific number of connector modules 33.

The upper portion 30 of housing 28 may include one or more barbed tabs 40 that project downward from a lateral surface thereof, and a pair of cutouts 42. The lower portion 32 of housing 28 may include one or more sleeves 44 (e.g., six sleeves 44) that project outward from a rear surface thereof, one or more slots 46 each configured to receive a respective barbed tab 40 of the upper portion 30 of housing 28, and cutouts 48 that generally align with the cutouts 42 of the upper portion of housing 28. To enclose the connector modules 33 within the housing 28, the upper potion 30 may be aligned with the lower portion 32 and the upper portion 30 moved toward the lower portion 32 until the barbed tabs 40 engage the slots 46 thereof.

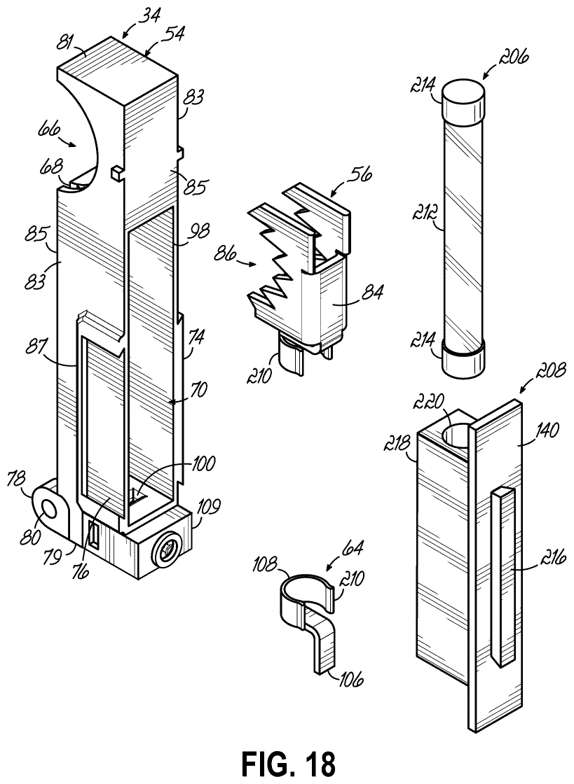

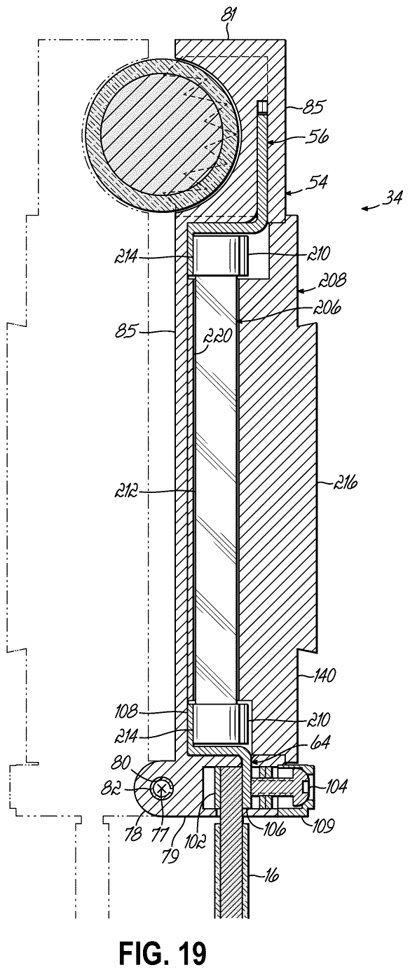

As best shown by FIGS. 18 and 19, each jaw assembly 34 may include a body 54, a blade 56, a line terminal 64, a protective device 206 (e.g., an overcurrent protective device), and a device holder 208. The body 54 of upper jaw assembly 34 may include the cable groove 66, blade slots 68, main cavity 70, terminal cavity 72, one or more keys 74, one or more keyways 76, and one or more hinge barrels 78 largely as described above with respect to FIGS. 2-7. However, rather than switch contacts, the distal ends of line terminal 64 and blade terminal 88 may each include a spring clip electrical contact 210.

The main cavity 70 may include the opening 98 that provides access to the main cavity 70 while the jaw assemblies 34 are in the closed position. The blade 56 may be configured so that when the blade 56 is fully inserted into the blade slots 68 of body 54, the spring clip electrical contact 210 of blade terminal 88 is positioned within the main cavity 70 at the distal end thereof. The line terminal 64 may include a proximal end 106 and a distal end 108 having an electrical contact in the form of another spring clip electrical contact 210. The electrical contact 210 of line terminal 64 may be positioned at the proximate end of the main cavity 70, and the proximal end 106 of line terminal 64 may extend through the passage 100 and into the terminal cavity 72.

The main cavity 70 of body 54 may be configured to contain the protective device 206, device holder 208, and spring clip electrical contacts 210. The protective device 206 may include a body 212 and a pair of contacts 214 operatively coupled by the body 212. The body 212 may include a protective circuit (e.g., a fusible link) that electrically couples the contacts 214 under normal operating conditions and electrically decouples the contacts 214 in response to the current flowing through the protective device 206 exceeding a predetermined threshold. The device holder 208 may include a stop plate 140, a grip 216 operatively coupled to one side of the stop plate 140, and a receptacle 218 that extends from the side of the stop plate 140 opposite that of the grip 216. The receptacle 218 may include a receptacle bore 220 configured to receive the protective device 206 and position the protective device 206 within the main cavity 70 of body 54 when the device holder 208 is inserted into the main cavity 70.

The device holder 208 may be inserted into the main cavity 70 after the protective device 206 is positioned in the receptacle 218. In response to insertion of the device holder 208, the spring clip electrical contacts 210 may establish an electrical connection with the contacts 214 of protective device 206. Use of the device holder 208 may facilitate insertion and removal of the protective device 206 as compared to inserting the protective device 206 directly into the main cavity 70 of body 54. The device holder 208 may also ensure that the protective device 206 is positioned correctly within the main cavity 70, and prevent damage to the protective device 206 during insertion into and removal from the jaw assembly 34.

The terminology used herein is for the purpose of describing particular embodiments only and is not intended to be limiting of the embodiments of the present invention. As used herein, the singular forms “a”, “an” and “the” are intended to include both the singular and plural forms, and the terms “and” and “or” are each intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the present invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The present invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. An insulation piercing connector for operatively coupling one or more conductors to a trunk cable including an insulating layer, comprising:
a first jaw assembly; and
a second jaw assembly hingedly coupled to the first jaw assembly, wherein:
at least one of the first jaw assembly and the second jaw assembly includes a blade, a line terminal, and a conditional electrical coupling device,
the blade is configured to penetrate the insulating layer of the trunk cable and make electrical contact with the trunk cable when the first jaw assembly and the second jaw assembly are in a closed position,
the line terminal is configured to receive at least one of the one or more conductors, and
the conditional electrical coupling device connects the blade to the line terminal.

2. The connector of claim 1, wherein the conditional electrical coupling device includes a switch mechanism.

3. The connector of claim 2, further comprising:
a bridge plate having a first electrical contact and a second electrical contact, wherein:
the at least one of the first jaw assembly and the second jaw assembly includes a body having a cavity with a first end and a second end opposite the first end,
the blade includes a third electrical contact positioned at the first end of the cavity,
the line terminal includes a fourth electrical contact positioned at the second end of the cavity, and
the bridge plate is configured to move within the cavity between a first position in which the first electrical contact is in contact with the third electrical contact and the second electrical contact is in contact with the fourth electrical contact such that the switch mechanism is in a closed state, and a second position in which at least one of the first electrical contact is out of contact with the third electrical contact or the second electrical contact is out of contact with the fourth electrical contact such that the switch mechanism is in an open state.

4. The connector of claim 3, further comprising:
a bridge plate guide including a first standoff, a second standoff, and a crossmember connecting the first standoff and the second standoff, wherein:
the bridge plate includes a first end and a second end each having a shape,
each standoff includes a guide channel having a cross-sectional shape that matches the shape of the first end and the second end of the bridge plate, and
each guide channel engages a respective one of the first end and the second end of the bridge plate such that the bridge plate is guided by the guide channel as the bridge plate moves between the first position and the second position.

5. The connector of claim 4, further comprising:
a bridge plate plunger including one or more connecting rods each having a proximal end and a distal end, a journal, and a stop plate that couples the journal to the proximal end of each of the one or more connecting rods, wherein:
the crossmember includes one or more guide bores,
the distal end of each connecting rod is connected to the bridge plate, and
each connecting rod of the bridge plate plunger passes through a respective one of the one or more guide bores so that the crossmember is positioned between the bridge plate and the stop plate.

6. The connector of claim 5, further comprising:
a rotary actuator;
a linkage operatively coupling the rotary actuator to the journal, wherein the linkage is configured to translate rotation of the rotary actuator into linear movement of the journal.

7. The connector of claim 4, wherein:
the crossmember includes a guide rod, and
the bridge plate includes a guide hole configured to engage the guide rod such that the bridge plate is further guided by the guide rod as the bridge plate moves between the first position and the second position.

8. The connector of claim 1, wherein the conditional electrical coupling device includes a protective device.

9. The connector of claim 8, further comprising:
a device holder that holds the protective device, wherein:
the at least one of the first jaw assembly and the second jaw assembly includes a body having a cavity with a first end and a second end opposite the first end,
the protective device includes a first electrical contact, a second electrical contact, and a protective circuit operatively coupled to the first electrical contact and the second electrical contact,
the blade includes a third electrical contact positioned at the first end of the cavity,
the line terminal includes a fourth electrical contact positioned at the second end of the cavity, and
the cavity is configured to receive the device holder and the protective device such that when the device holder is inserted into the cavity, the first electrical contact engages the third electrical contact and the second electrical contact engages the fourth electrical contact such that the protective device is electrically coupled to the blade and the line terminal.

10. The connector of claim 1, wherein:
the first jaw assembly and the second jaw assembly are hingedly coupled to each other by a hinge defining a hinge axis;
the first jaw assembly includes a first body having first key on one side of the first body and a first keyway on another side of the first body opposite the first side;
the second jaw assembly includes a second body having a second key on one side of the second body and a second keyway on another side of the second body opposite the first side; and
each key and each keyway is positioned on the respective side of the respective body at a same radius from the hinge axis.

11. The connector of claim 10, wherein:
the first jaw assembly is one of a plurality of first jaw assemblies,
the second jaw assembly is one of a plurality of second jaw assemblies,
each first jaw assembly is hingedly coupled to a respective second jaw assembly to define a respective connector module,
the connector includes at least two connector modules, and
each of the at least two connector modules is operatively coupled to at least one other connector module by engagement of one or more keys with one or more keyways.

12. The connector of claim 1, further comprising:
a compression mechanism configured to hold the first jaw assembly and the second jaw assembly in the closed position.

13. The connector of claim 12, wherein the compression mechanism includes:
a fastener including a head, a shank, and a threaded end,
a first bracket configured to engage one of the first jaw assembly and the second jaw assembly, and including a smooth bore configured to allow the threaded end of the fastener to pass therethrough and to allow free rotation of the shank of the fastener,
a second bracket configured to engage the other of the first jaw assembly and the second jaw assembly, and including a threaded bore configured to receive the threaded end of the fastener,
wherein the compression mechanism is configured to apply a closing force to the first jaw assembly and the second jaw assembly in response to the fastener being rotated in a direction that causes the threaded end thereof to move into the threaded bore as the fastener is rotated.

14. A method of connecting one or more conductors to a trunk cable including an insulating layer using a connector including a first jaw assembly hingedly coupled to a second jaw connector, comprising:
placing the first jaw assembly and the second jaw assembly into a closed position such that one or more blades of at least one of the first jaw assembly and the second jaw assembly penetrate the insulating layer of the trunk cable and make electrical contact with the trunk cable;
installing a conditional electrical coupling device in one of the first jaw assembly and the second jaw assembly, the conditional electrical coupling device connecting at least one of the one or more blades to a line terminal of the one of the first jaw assembly and the second jaw assembly, and
connecting at least one of the one or more conductors to the line terminal of the one of the first jaw assembly and the second jaw assembly.

15. The method of claim 14, wherein the conditional electrical coupling device includes at least one of a switch mechanism and a protective device.

16. The method of claim 15, wherein the conditional electrical coupling device includes the switch mechanism, the one of the first jaw assembly and the second jaw assembly includes a cavity, the one or more blades include a first electrical contact, the line terminal includes a second electrical contact, and further comprising:
inserting a bridge plate having a third electrical contact and a fourth electrical contact into the cavity of the one of the first jaw assembly and the second jaw assembly; and
selectively positioning the bridge plate within the cavity so that the third electrical contact contacts the first electrical contact of the one or more blades and the fourth electrical contact contacts the second electrical contact of the line terminal.

17. The method of claim 16, further comprising:
selectively positioning the bridge plate within the cavity so that the third electrical contact is out of contact with the first electrical contact of the one or more blades and the fourth electrical contact is out of contact with the second electrical contact of the line terminal.

18. The method of claim 16, wherein selectively positioning the bridge plate within the cavity comprises:
rotating a rotary actuator; and
translating the rotation of the rotary actuator into a linear movement of the bridge plate using a linkage that operatively couples the rotary actuator to the bridge plate.

19. The method of claim 15, wherein the conditional electrical coupling device includes the protective device, the one of the first jaw assembly and the second jaw assembly includes a cavity, the one or more blades include a first electrical contact, the line terminal includes a second electrical contact, and further comprising:
inserting the protective device into the cavity of the one of the first jaw assembly and the second jaw assembly such that a third electrical contact of the protective device contacts the first electrical contact of the one or more blades and a fourth electrical contact of the protective device contacts the second electrical contact of the line terminal.

20. The method of claim 19, wherein the protective device electrically couples the one or more blades to the line terminal, and further comprising:
in response to a current flowing through the protective device exceeding a threshold, electrically decoupling the one or more blades from the line terminal.
